(19) United States
(12) Patent Application Publication
(10) Pub. No.: US 2011/0120889 A1
(43) Pub. Date: May 26, 2011

(54) Detection Device of Screen-Printed Electrode With High Sensitivity

(75) Inventors: Ja-An HO, Hsinchu (TW); Wei-Ching LIAO, Hsinchu (TW)

(73) Assignee: NATIONAL TSING HUA UNIVERSITY, HSINCHU (TW)

(21) Appl. No.: 12/708,869

(22) Filed: Feb. 19, 2010

(30) Foreign Application Priority Data
Aug. 27, 2009 (TW) 098128794

(51) Int. Cl. G01N 27/26

(52) U.S. Cl. 205/777.5; 204/403.01

(57) ABSTRACT

A detection device for detecting Escherichia coli in a sample includes: an electrode coated with a metal layer, which is further bound with a first nucleic acid sequence; and a second nucleic acid sequence bound with a liposome having an electrochemical material. The second nucleic acid sequence competes with the first nucleic acid sequence for a complementary binding ability, and the liposome is broken to release the electrochemical material. Then, the release electrochemical material is determined so as to estimate whether a third nucleic acid sequence specific for E. coli exists in the sample, where the third nucleic acid sequence is complementary with the first nucleic acid sequence. A trace amount (10⁻¹⁵ mole) of first nucleic acid sequence can be detected using the detection device, which is has advantages of low price, speedy reaction, portability and minimization etc. and can be used for detecting other molecules.

### FIELD OF THE INVENTION

The present invention relates to a detection device. In particular, the present invention relates to a detection device of the screen-printed electrode (SPE) for detecting the biomolecules in a sample. The detection device has advantages of high sensitivity, low price, rapid reaction, small detection device/chip size (i.e. portability), low manpower demand and compatible with other minimized technology.

### BACKGROUND OF THE INVENTION

The current method for detecting chemicals, microorganisms or cells from the sample includes the detection of particular/specific genes, proteins and molecules of the microbes detected by microbial biochemical assays and molecular biology techniques, etc. However, the multiple steps of biochemical tests are necessary in these detection assays. Alternatively, the further cultivation or amplification is necessary due to the amount of microbes in the sample. Cultivation or amplification increases the chances of microbial mutation and molecular variation to result in the decreased accuracy and sensitivity of detection. Further, the detection result might be distorted or could not be evaluated early due to the limitation of sensitivity of the detection device. Therefore, it is urgent to develop technologies which are able to rapidly and accurately detect the particular molecules and increase the detection sensitivity.

One of the examples is the detection of Escherichia coli O157 strain (Xu et al., 2003), which is a verocytotoxin-producing pathogen able to cause hemorrhagic colitis and severe hemolytic uremic syndrome, which may result in death via acute or chronic renal failure (Karmali, 1989). E. coli O157 is commonly found in ground beef, unpasteurized or raw milk, cold sandwiches, vegetables, apple cider and drinking water; it can be transmitted through contaminated foods and drinks or spread by person-to person contact (Griffin et al., 1991). At present, E. coli O157 strain is detected by performing the microbial incubation and polymerase chain reaction (PCR), and it spends time and the detection cost. Since E. coli O157 breaks out in many countries, there is an urgent need to develop sensitive, specific, rapid detection tools to combat diseases caused thereby and also to speed up the clinical diagnosis, surveillance, and monitoring of the presence of such pathogens in foodstuffs.

It is therefore attempted by the applicant to deal with the above situation encountered in the prior art.

### SUMMARY OF THE INVENTION

For overcoming the problems existing in the current techniques for detecting chemicals, microbes and their particular/specific molecules, a rapid, highly sensitive, accurate and reliable detection device is provided in the present invention, in which the gold nanoparticles are electrodeposited on the screen-printed electrode (SPE) to increase the electronic transmission efficiency and own the capability of modifying thiol-DNA. The electrochemical active substance is encapsulated with the liposome. The electrochemical active substance signals are detected by the electrochemical analyzer when the electrochemical active substance is released.

E. coli O157 strain is performed as the embodiment of the present invention, and a detection method of E. coli O157 is provided. The target rfbE gene, highly conserved in E. coli O157 is detected with electrochemical theory, in which the gold nanoparticles are electrodeposited on the SPE and the capture probe DNA is modified on the gold nanoparticles. The target rfbE gene (i.e. complementary with the capture probe DNA) and the reporter-tagged gene carrying a liposome encapsulated the electrochemical active substance for the capture probe DNA, and the released electrochemical active substance is transformed as the current signal. The limit of detection and the limit of quantification for this device and the detection method are up to 10⁻¹⁸ attomole (amol) and 10⁻¹⁵ femtomole (fmol), respectively, to effectively detect the existence of E. coli O157 strain.

A device for detecting an Escherichia coli in a sample is provided in the present invention. The device includes: an electrode having a surface coupled a metal, and the metal bound with a first nucleic acid; and a second nucleic acid bound with a liposome and being complementary with a first nucleic acid in sequence, and a material being contained in the liposome. The sample and the second nucleic acid compete a complementary binding capacity with the first nucleic acid, the material is released from the liposome, and whether there is a third nucleic acid in the sample is evaluated by the substance, and the third nucleic acid is a gene of the E. coli.

Preferably, the metal is bound with a 5′-end of the first nucleic acid.

Preferably, the first nucleic acid further has a thiol group bound with the 5′-end of the first nucleic acid and the metal individually.

Preferably, the substance is an electrochemical active substance.

Preferably, the electrochemical active substance comprises a hexaammineruthenium(III) chloride (Ru(NH₃)₆Cl₃).

Preferably, the metal comprises a gold, a platinum, a silver and other metals.

Preferably, the device has a detection limit of at least 2.1×10⁻¹⁹ mole of the third nucleic acid, and the device has a quantification limit of at least 2.46×10⁻¹⁵ mole of the third nucleic acid.

Preferably, the E. coli is an Escherichia coli O157 strain.

A method for detecting an Escherichia coli in a sample is further provided in the present invention. The method includes steps of: (a) providing a first nucleic acid immobilized on an electrode; (b) providing a second nucleic acid bound with a liposome, the second nucleic acid being complementary with the first nucleic acid in sequence, the liposome comprising a substance; (c) providing the sample, such that the sample and the second nucleic acid competes a complementary binding activity with the first nucleic acid; (d) releasing the substance by breaking out the liposome; and (e) evaluating whether there is a third nucleic acid complementary with the first nucleic acid in the sample by the substance, and the third nucleic acid being a gene of the E. coli.

Preferably, the electrode in step (a) further includes a surface coated with a metal thereon. The step (d) is performed by one step selected from a group consisting of a drying, a heating, a freezing, a mechanic pressure, a vibration and a composition thereof. The step (e) further includes a step (e1) of detecting the released substance for an electronic potential and a circuit.

Preferably, the substance is an electrochemical active substance.

A detection device is further provided in the present invention. The detection device includes: a substrate having a surface bound with a first molecule; and a second molecule having a binding activity with the first molecule and labeling an indicator, wherein a third molecule and the second molecule compete a binding activity with the first molecule, and an amount of the third molecule is evaluated by an remaining amount of the indicator.

Preferably, the surface further binds with the first molecule via a metal.

Preferably, the first molecule is modified with a modifier, and then the first molecule binds with the substrate via the modifier.

Preferably, the first molecule, the second molecule and the third molecule respectively are one selected from a group consisting of a nucleic acid, an oligopeptide, a polysaccharide, a polymer, a chelate complex and a combination thereof.

Preferably, the indicator is encapsulated with a fourth molecule, and the fourth molecule comprises a liposome.

Preferably, the second molecule is the same with the third molecule on the structure, and the second molecule cannot be bound with the third molecule.

Preferably, the substrate is a electrode, which further is a screen-printed electrode or interdigital electrode or other suitable microelectrode.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 illustrates the kinetic analysis of the interaction between the target ss-DNA and the immobilized capture probe ss-DNA in the present invention. The concentrations of the target ss-DNA are 0, 15.63, 31.25, 62.5, 125, 250 and 500 nM.

FIG. 2 illustrates the result of cyclic voltammetric assay of Fe(CN)₆^{3-/4-} on the bare Au-nanostructured SPE (solid curve) and the capture DNA-modified electrode (dashed curve).

FIG. 3 illustrates chronocoulometric (CC) response curves for the capture DNA-modified electrode in the absence (solid curve) and presence (dashed curve) of 50 μM Ru(NH₃)₆³⁺.

FIG. 4 illustrates the square-wave voltammetric traces acquired when using the competitive genosensor to detect different amounts of the target rfbE gene.

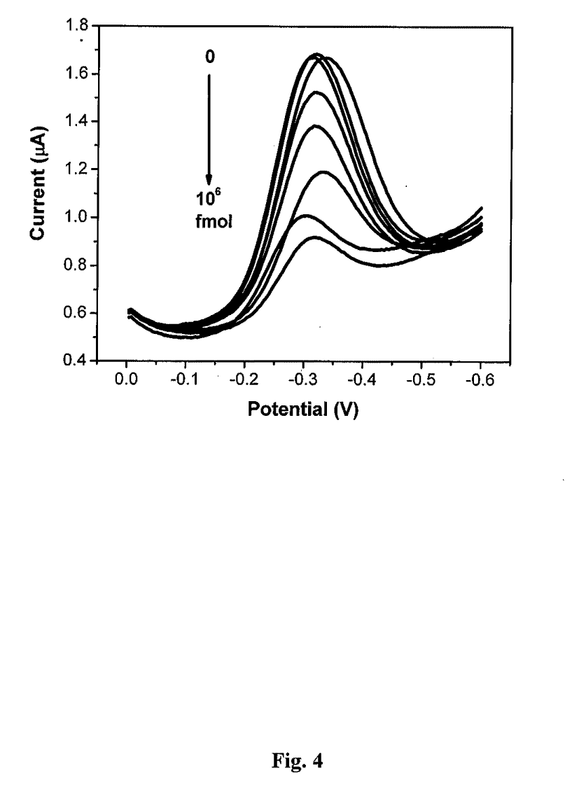

FIG. 5 illustrates the dose-response curve for the rfbE target gene. Each data point represents an average ±1 standard deviation of three replicates.

FIG. 6 illustrates the square-wave voltammetric traces obtained from the competitive genosensor hybridized with 2.5×10⁵ fmol of (a) the target rfbE gene and (b) ssrA gene. The curve (c) is the control assay (control group) performed without the addition of the target rfbE gene.

### DETAILED DESCRIPTION OF THE PREFERRED EMBODIMENT

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

### Biological Experiments

I. Experimental Methods:

The sequences used in the present embodiment were listed in Table 1, wherein the 5′-ends of the capture probe single strand (ss)-DNA (SEQ ID NO. 1) and the reporter probe ss-DNA (SEQ ID NO. 2) were further modified by the sulfhydryl (HS—(CH₂)₆—) groups.

TABLE 1

| Name | SEQ ID NO. | Sequence |
|---|---|---|
| Capture probe | 1 | 5′-ATGTACAGCTA |
| ss-DNA | | ATCCTTGGCC-3′ |
| Reporter probe | 2 | 5′-GGCCAAGGATT |
| ss-DNA | | AGCTGTACAT-3′ |
| Hybridization | 3 | 5′-GGCCAAGGATT |
| target ss-DNA | | AGCTGTACAT-3′ |
| ssrA ^{a} | 4 | 5′-TCGAACTATC |
| | | CCTGTCGAAT-3′ |

^{a} Sequence designated for the ssrA gene of Listeria monocytogenes.

1. Surface Plasmon Resonance (SPR) Assay:

First, the golden (Au) surface of a Biacore sensor chip (SIA Kit Au, GE Healthcare) was rinsed with 1 M NaCl containing 50 mM NaOH. The SPR analysis was initiated by injecting the running buffer (containing 10 mM Tris-HCl, 1 mM EDTA (ethylenediaminetetraacetic acid) and 1 M NaCl, pH 7.4) through the system at a rate of 30 d/min until the baseline became stable. One channel was unmodified to provide an additional reference surface, and the other channel was modified with capture probe DNA (30 μl of 1 μM DNA) in 1 M potassium phosphate buffer (containing 0.5 M KH₂PO₄ and 0.5 M K₂HPO₄; pH 7) at a rate of 30 μ/min. Subsequently, 5 mM Tris-HCl buffer containing 10 mM NaCl (pH 7.4) was introduced to wash out the free, unbound DNA probe. The kinetic binding study was then performed by analyzing various concentrations of target DNA (0, 5.63, 31.3, 62.5, 125, 250, and 500 nM), which were obtained through a serial 2-fold dilution of a stock 500 nM solution. Sodium chloride (1 M) containing 50 mM NaOH was used as the regeneration buffer to dissociate the capture probe ss-DNA probes. Finally, the SPR data were evaluated using Biacore T100 evaluation software to calculate the values of the kinetic parameters kₐ and k_{d}.

2. Fabrication of Electrode:

Prior to immobilizing the capture probe ss-DNA, the working electrode of the screen-printed electrode (SPE) was preconditioned electrochemically by cycling the potential repeatedly between −0.6 and +0.6 at 0.5 Volt/sec in 20 mM Tris-HCl buffer (pH 7.4). An Au nanostructured platform was formed on the working electrode of the SPE in a single step through the controlled electrodeposition (Ho et al., 2009), where the SPE was placed in a solution of 10 mM HAuCl₄ containing 0.1 M KCl, and then the controlled electrodeposition was performed at −0.66 Volt for 10 seconds. The SPE was dried in air after rinsing with the distilled deionized water. Subsequently, a droplet (6 μl) of a 1 μM solution of the thiolated capture DNA in 1 M potassium phosphate buffer (pH 7.0) was placed onto the working electrode and left to react overnight at the ambient temperature. Finally, the thiol-capped ss-DNA self-assembled SPE (ss-DNA/SPE) was rinsed in 5 mM Tris-HCl buffer (pH 7.4) containing 10 mM NaCl. The Au nanoparticles were coated on this SPE for increasing the electronic transmission efficiency, and the thiol group was bound on the Au nanoparticles.

3. Preparation of Reporter Gene-Tagged Liposomal Biolabels:

The reporter DNA-tagged liposomes were prepared from a lipid mixture using the reversed-phase evaporation method (Rule et al., 1996). A lipid mixture consisted of DPPC (dipalmitoylphosphatidylcholine), cholesterol, DPPG (dipalmitoylphosphatidylglycerol), and PE-MCC (1,2-dihexadecanoyl-sn-glycero-3-phosphoethanolamine-N-[4-(p-maleimidomethyl)-cyclohexanecarboxamide]) (10:10:1:0.25 molar ratio) was dissolved in a mixture of chloroform, isopropyl ether, and methanol (6:6:1 volume ratio, 4 mL), and then 150 mM aqueous Ru(NH₃)₆Cl₃ (hexaammineruthenium(III) chloride, abbreviated as RuHex, 1 ml) was added. After the sonication of the mixture for 3 minutes, the organic solvent was evaporated under the reduced pressure, and a milky-white jelly of liposomes were left. Another aliquot of Ru(NH₃)₆Cl₃ was added to this residue and then the mixture was sonicated for 3 minutes and vortexed at 45° C. The liposome sizes were regulated via extrusion 20 times through 1- and 0.4-μm polycarbonate filters, and the free, unencapsulated Ru(NH₃)₆Cl₃ was removed through the gel filtration. The collected liposomes fractions were incubated overnight (at 4° C. on a shaker) with an appropriate amount of the 5′-thiol capped reporter probe. Finally, the reaction mixture was passed through a Sephadex G-75 column to separate the DNA-tagged liposomes from the free reporter probe. This liposome suspension was stored at 4° C. until required for use.

4. Characterization of Reporter Gene-Tagged Liposomal Biolabels:

The liposomes were characterized using a particle analyzer and a zeta (ξ) potential analyzer to determine their sizes and electrokinetic potentials. In addition, the phospholipid contents of the liposomes were assayed by using Bartlett's phosphorus assays (Barlett, 1959), which were performed as follows. Samples of liposomes (10 or 20 μl) were dehydrated at 155° C. for 10 minutes, and then the deionized water (1 ml) was added. Each sample was digested to inorganic phosphates with 10 N H₂SO₄ (0.5 ml) for 3 hours at 155° C. Hydrogen peroxide (30%, 100 μl) was added to each sample, and then the mixtures were returned to the oven for 1.5 hours. The tubes were cooled to ambient temperature prior to, and vortexed vigorously following, each addition. Finally, 0.22% ammonium molybdate (4.6 ml) and the Fiske-Subbarow reagent (prepared by mixing sodium bisulfite (15% (w/v), 40 ml), sodium sulfite (0.2 g), and 1-amino-4-naptholsulfonic acid (0.1 g) at ambient temperature for 1 h and then filtering out the undissolved solids; 0.2 ml) were added. The tubes were heated in a boiling-water bath for 7 minutes and then quickly cooled in an ice-water bath. The absorbance at 830 nm was recorded. The standards prepared from DPPE stock (2.23 mg/ml in chloroform/methanol (8:2)) were subjected to the same procedure concurrently. The phospholipid content of the liposomes was determined from a calibration curve of the standards. The total lipid concentration was calculated by multiplying the phospholipids concentration by the initial ratio of total lipid to phospholipid.

5. Assay Performance:

The hybridization buffer (60% formamide, 6×SSC (saline-sodium citrate buffer), 0.15 M sucrose, 0.8% Ficoll type 400 and 0.01% Triton X-100) was pipetted onto the ss-DNA/SPE to incubate for 20 minutes, for activating the capture ss-DNA self-assembled SPE surface. The subsequent hybridization was performed by directly applying the target sequence and liposome mixture at an appropriate dilution onto the working electrode and incubating the system for 40 minutes at room temperature with continuous shaking. A fixed volume (1 μl) of the target sequence solution was introduced onto the sensor in each assay, and the ratio of the hybridization buffer and the liposome solution was adjusted accordingly to obtain a total volume of 5 μl. Next, the electrode was rinsed with a solution containing 10% formamide, 3×SSC, 0.2 M sucrose, 0.2% Ficoll type 400 and 0.01% Triton X-100 to remove the nonbound target gene and the reporter DNA-tagged liposomes. The SPEs were then dried for 20 minutes under vacuum at ambient temperature prior to electrochemical analysis. The electrochemical measurements were performed in 20 mM Tris-HCl (pH 7.4). The reduction signal of RuHex was measured using square wave voltammetry (SWV) by scanning from 0 to −0.6 Volt with an amplitude of 25 mV and a step potential of 4 mV at 15 Hz.

II. Experimental results:

1. Analysis of DNA Kinetic Binding Using SPR Spectroscopy:

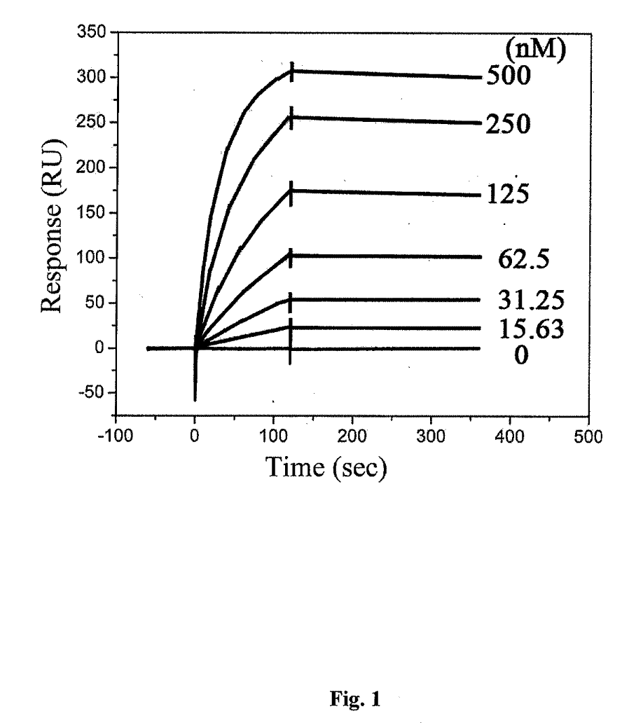

To detect the binding affinity between the synthetic capture probe ss-DNA and its complementary target ss-DNA, the kinetic function of an SPR spectrometer was used to determine the binding parameters, in which the various concentrations of the target ss-DNA was interact with the immobilized capture ss-DNA on the sensor chip. The experimental results were shown in FIG. 1, where kₐ was equal to 5.76 (±0.09)×10⁴ M⁻¹ s⁻¹ (RSD=0.02, RSD is referred to the redundant sign bit) and k_{d} was equal to 6.75 (±0.30)×10⁻⁵ s⁻¹ (RSD=0.04). The equilibrium dissociation constant K_{D}, calculated based on the ratio k_{d}/kₐ, was 1.17 (±0.07)×10⁻⁹M (RSD=0.06).

2. Characterization of Liposomal Biolabels:

The DNA-tagged liposomal biolabels is being the signal amplifiers in the present invention. The average diameter and the zeta (ξ) potential of the resulting liposomes were 212.4 nm and −18.26 mV, respectively, suggesting that the average volume of a single liposome was 6.3×10⁻¹⁹ L, with an entrapped volume (assuming a bilayer thickness of 4 nm) of 5.0×10⁻¹⁹ L. Assuming that the RuHex concentration inside the liposomes was equal to that (150 mM) in the original solution and comparing the current signal of the lysed liposomes with that of the standard RuHex solution, the phospholipid concentration was calculated as 7.5×10¹⁶ liposomes/L and each liposome contained 4.5×10⁴ molecules of RuHex. The phospholipid concentration determined using Bartlett's phosphorus assay was 0.25 g/L. On the basis of the average size and the phospholipid concentration in the liposome preparation, the liposome concentration was calculated as 1.5×10¹⁶ liposomes/L.

3. Characterization of Bioelectrodes:

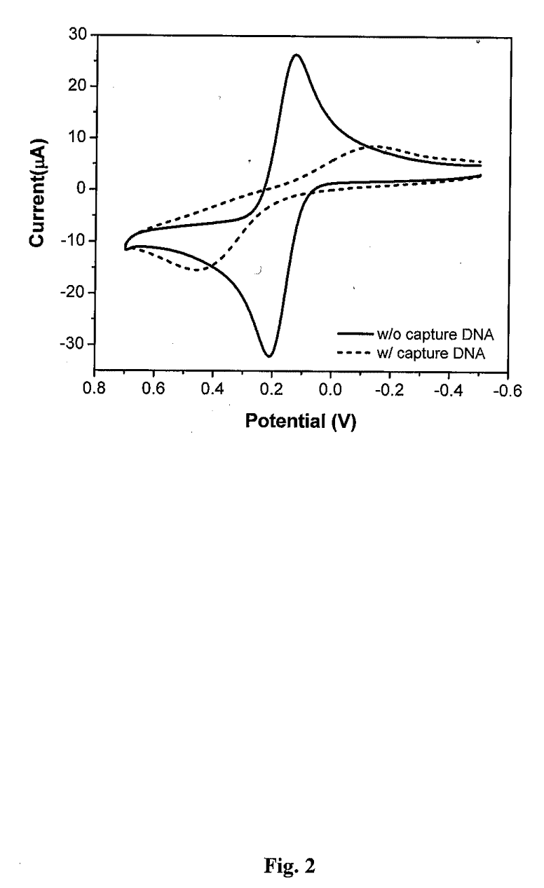

Please refer to FIG. 2, which illustrates the result of cyclic voltammetric assay of Fe(CN)₆^{3-/4-} on the bare Au-nanostructured SPE (nanoAu/SPE) and the capture DNA-modified electrode (DNA/SPE) in 100 mM PBS (containing 0.15 M NaCl, pH 7.0). In FIG. 2, there was a pair of peaks corresponding to the reduction and oxidation of Fe(CN)₆^{3-/4-} on the bare nanoAu/SPE surface; however, the redox reaction of Fe(CN)₆^{3-/4-} was markedly less reversible on the DNA/SPE surface, as evidenced by increased peak splitting (ΔEp became larger). This phenomenon was due to repulsive electrostatic interactions between the negative DNA layer and the anionic Fe(CN)₆^{3-/4-}, which impeded the anions from reaching the electrode surface. These observations suggested that the capture probes were successfully immobilized on the nanoAu/SPE. Furthermore, the presence of the capture probe DNA on the surface of the nanoAu/SPE was verified by using X-ray photoelectron spectroscopy (XPS). The intensity of the S 2p peak from the capture probe-modified electrode was higher than that from the bare nanoAu/SPE, once again confirming that the capture probes were immobilized on the electrode.

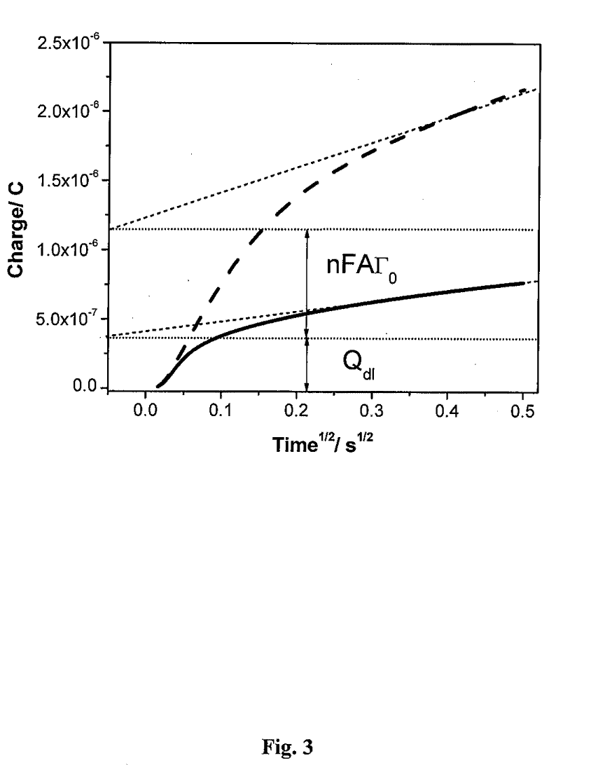

Next, the density of the self assembled capture DNA on the electrode surface was determined by using the chronocoulometric (CC) analysis procedure (Steel et al., 1998) and employing 50 μM Ru(NH₃)₆³⁺ containing 10 mM Tris-HCl (pH 7.4) at a pulse period of 250 ms and a pulse width of 300 mV. The results were shown in FIG. 3, which illustrates the determined redox charges of Ru(NH₃)₆³⁺. The surface density of the capture probe DNA was estimated as 1.14 (±0.07)×10¹³ molecules/cm² with addition of 1.0 mM capture probe DNA on the electrode (the coverage rate was calculated to be 35.8%).

4. Optimization of Assay System:

The optimal amounts of the capture probe ss-DNA and the liposomal biolabels used for the electrochemical bioassay were further determined. First, an excess of the DNA-tagged liposomes to the sensing surface was hybridized with various amounts of the immobilized capture probe DNA (0.1, 1.0, and 10 μM), and the results were shown in Table 2. In Table 2, the signals were compared between the control group (without addition of the target ss-DNA) and the experimental group (with addition of 2×10⁵ femtomole (fmol) of the target ss-DNA). When more capture probes were immobilized on the SPE, the higher current signals from the control group were obtained. The lowest current signal resulted when using 0.1 μM capture probe DNA, presumably because the fewer hybridization sites were provided by the limited number of the immobilized capture probe DNA. By comparing the two sets of data obtained when using 1.0 and 10 μM immobilized capture probe DNA, a slightly higher current signal from the immobilization of 10 μM capture probe DNA on the SPE surface than that of 1.0 μM one was observed. Nevertheless, no significant difference in the signal ratio (i.e. the ratio of the currents obtained from the experimental and control groups) was detected. It could be known that an excess of the binding sites might lead to a poor detection limit; thus, 1.0 μM could be the optimal capture probe DNA concentration for the immobilization process.

TABLE 2

| Capture DNA | | | | |
|---|---|---|---|---|
| concentration | Density | Control | Experiment | Signal ratio |
| (μM) | (molecule/cm²) | (μA) | (μA) | percentage(%) |
| 0.1 | 3.90(±0.92) × 10¹² | 0.401(±0.024) | 0.347(±0.003) | 86.58 |
| 1 | 1.14(±0.07) × 10¹² | 0.947(±0.017) | 0.344(±0.015) | 36.34 |
| 10 | 1.15(±0.05) × 10¹³ | 0.965(±0.083) | 0.333(±0.017) | 34.51 |

Table 3 illustrates the result of the competitive binding assay on the immobilized capture probe DNA between the DNA-tagged liposomes and the target rfbE gene. Samples of the liposome solution (1 μl, containing 7.5×10¹⁰ liposomes) were diluted by 2-, 5-, and 10-fold. It was found that the optimal concentration of the added liposome concentration was 5-fold dilution (i.e. 1 μl of the liposome solution diluted to a final volume of 5 μl in the appropriate buffer). This 5-fold diluted sample contained 7.5×10¹⁰ liposomes and encapsulated 5.6×10⁻⁹ mol of the RuHex marker.

TABLE 3

| | | | Signal ratio |
|---|---|---|---|
| DNA-tagged liposome | Control | Experiment | percentage |
| diluted concentration | (μA) | (μA) | (%) |
| 1/10 | 0.726(±0.029) | 0.260(±0.015) | 35.77 |
| ⅕ | 0.944(±0.009) | 0.267(±0.005) | 28.29 |
| ½ | 0.947(±0.017) | 0.344(±0.015) | 36.34 |

5. Determination of rfbE Target:

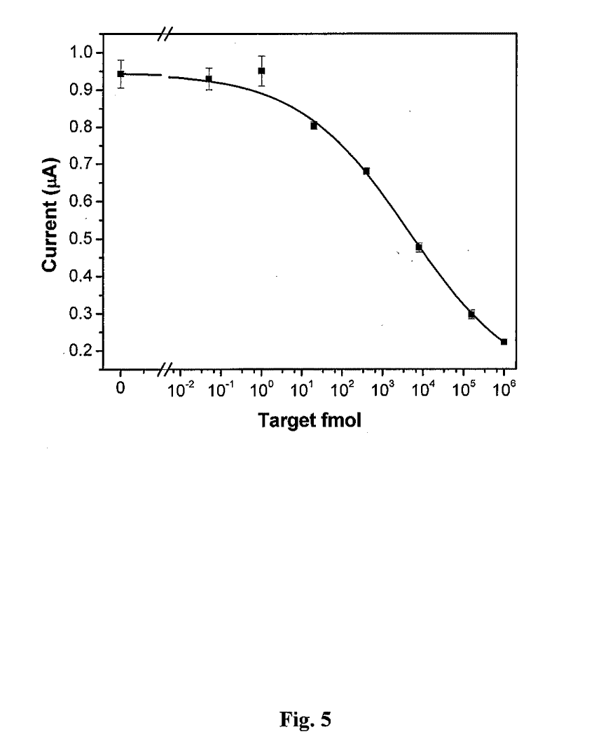

This experiment was performed to develop a competitive binding assay that facilitates the detection of an unknown amount of nonlabeled target ss-DNA with the help of a known amount of a liposome-labeled ss-DNA competitor. Competitive binding was observed after incubating the sensing surface with various mixtures containing liposome-labeled and nonlabeled target ss-DNA. The target rfbE gene (SEQ ID NO. 3) at contents was ranged from 5×10⁻² to 10⁶ fmol, and the current signals of the released liposomal Ru(NH₃)₆³⁺ were obtained by using SWV. The results were shown in FIG. 5. In the sigmoidally shaped dose-response curve of FIG. 5, the linear portion was over the range from 1 to 10⁶ fmol. An increase in the concentration of the target ss-DNA during the hybridization resulted in the fewer liposome-labeled ss-DNA binding to the immobilized capture probe DNA, which led to a decrease in the peak current. The current signal decreased in a dose-dependent manner with respect to the amount of target gene present in the range from 1 to 10⁶ fmol, and a limit of detection (LOD) was 0.75 attomole (amol) per assay (defined by substracting 3 times the standard deviation of the control) and the limit of quantification was 3.26 fmol per assay (defined by subtracting 10 times the standard deviation of the control).

In another embodiment, the LOD was ranged between 0.21 and 1.85 amol in an assay, and the limit of quantification was ranged between 2.46 and 4.3 fmol.

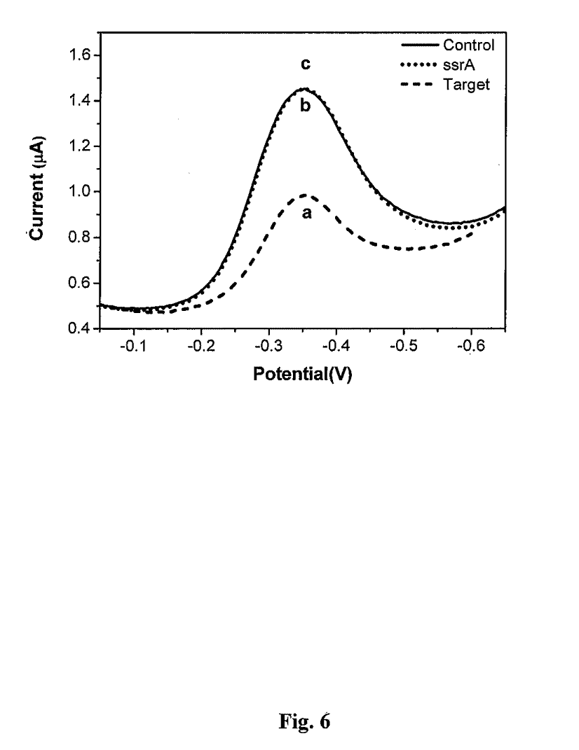

In addition, to test the sensor for its ability to withstand nonspecific hybridization, a non-complementary ssrA sequence (SEQ ID NO. 4) was substituted for the target ss-DNA, and its interaction with the capture probe-modified electrode was investigated. Please refer to FIG. 6, the better hybridization was observed for the complementary target gene, which lead to a decrease in the reduction current. No significant change in the current signal occurred in the presence of the non-complementary ssrA sequence, suggesting that no hybridization occurred between the capture probe DNA and ssrA sequence. Thus, the gene sensor of the present invention exhibits the specificity for the recognition of its target rfbE gene.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A device for detecting an Escherichia coli in a sample, the device comprising:
an electrode having a surface coupled a metal, and the metal bound with a first nucleic acid; and
a second nucleic acid bound with a liposome and being complementary with a first nucleic acid in sequence, and a material being contained in the liposome;
wherein the sample and the second nucleic acid compete a complementary binding capacity with the first nucleic acid, the material is released from the liposome, and whether there is a third nucleic acid in the sample is evaluated by the substance, and the third nucleic acid is a gene of the E. coli.

2. The device according to claim 1, wherein the metal is bound with a 5′-end of the first nucleic acid.

3. The device according to claim 2, wherein the first nucleic acid further has a thiol group bound with the 5′-end of the first nucleic acid and the metal individually.

4. The device according to claim 1, wherein the substance is an electrochemical, active substance.

5. The device according to claim 1, wherein the electrochemical active substance comprises a hexaammineruthenium(III) chloride (Ru(NH₃)₆Cl₃).

6. The device according to claim 1, wherein the metal comprises a gold, a platinum, a silver and other metals.

7. The device according to claim 1, wherein the device has a detection limit of at least 2.1×10⁻¹⁹ mole of the third nucleic acid.

8. The device according to claim 1, wherein the device has a quantification limit of at least 2.46×10⁻¹⁵ mole of the third nucleic acid.

9. The device according to claim 1, wherein the E. coli is an Escherichia coli O157 strain.

10. A method for detecting an Escherichia coli in a sample, the method comprising steps of:
(a) providing a first nucleic acid immobilized on an electrode;
(b) providing a second nucleic acid bound with a liposome, the second nucleic acid being complementary with the first nucleic acid in sequence, the liposome comprising a substance;
(c) providing the sample, such that the sample and the second nucleic acid compete a complementary binding activity with the first nucleic acid;
(d) releasing the substance by lysing the liposome; and
(e) evaluating whether there is a third nucleic acid complementary with the first nucleic acid in the sample by the substance, and the third nucleic acid being a gene of the E. coli.

11. The method according to claim 10, wherein the electrode in step (a) further comprises a surface coated with a metal thereon.

12. The method according to claim 10, wherein the step (d) is performed by one step selected from a group consisting of a drying, a heating, a freezing, a mechanic pressure, a vibration and a composition thereof.

13. The method according to claim 10, wherein the step (e) further comprises a step (e1) of detecting the released substance for an electronic potential and a circuit.

14. The method according to claim 10, wherein the substance is an electrochemical active substance.

15. A detection device, comprising:
a substrate having a surface bound with a first molecule; and
a second molecule having a binding activity with the first molecule and labeling an indicator,
wherein a third molecule and the second molecule compete a binding activity with the first molecule, and an amount of the third molecule is evaluated by an remaining amount of the indicator.

16. The detection device according to claim 15, wherein the surface further binds with the first molecule via a metal.

17. The detection device according to claim 15, wherein the first molecule is modified with a modifier, and then the first molecule binds with the substrate via the modifier.

18. The detection device according to claim 15, wherein the first molecule, the second molecule and the third molecule respectively are one selected from a group consisting of a nucleic acid, an oligopeptide, a polysaccharide, a polymer, a chelate complex and a combination thereof.

19. The detection device according to claim 15, wherein the indicator is encapsulated with a fourth molecule, and the fourth molecule comprises a liposome.

20. The detection device according to claim 15, wherein the second molecule is the same with the third molecule on the structure.

21. The detection device according to claim 15, wherein the second molecule cannot be bound with the third molecule.

22. The detection device according to claim 15 wherein the substrate is a electrode.

23. The detection device according to claim 22, wherein the electrode comprising a screen-printed electrode, interdigital electrode or microelectrode.


SEQUENCE LISTING (4 sequences)

SEQ ID NO: 1 - DNA, 21 bp, Escherichia coli
  Escherichia coli Capture probe ss-DNA
atgtacagctaatccttggcc

SEQ ID NO: 2 - DNA, 21 bp, Escherichia coli
  Escherichia coli Capture probe ss-DNA
ggccaaggattagctgtacat

SEQ ID NO: 3 - DNA, 21 bp, Escherichia coli
  Escherichia coli Hybridization target ss-DNA
ggccaaggattagctgtacat

SEQ ID NO: 4 - DNA, 20 bp, Listeria monoctogenes
  Listeria monoctogenes Hybridization ssrA gene
tcgaactatccctgtcgaat